(19) United States
(12) Patent Application Publication
(10) Pub. No.: US 2024/0378913 A1
(43) Pub. Date: Nov. 14, 2024

(54) INFORMATION PROCESSING DEVICE, INFORMATION PROCESSING METHOD, AND COMPUTER PROGRAM PRODUCT

(71) Applicants: KABUSHIKI KAISHA TOSHIBA, Tokyo (JP); TOSHIBA DIGITAL SOLUTIONS CORPORATION, Kawasaki-shi (JP)

(72) Inventor: Ryohei TANAKA, Kawasaki (JP)

(73) Assignees: KABUSHIKI KAISHA TOSHIBA, Tokyo (JP); TOSHIBA DIGITAL SOLUTIONS CORPORATION, Kawasaki-shi (JP)

(21) Appl. No.: 18/659,411

(22) Filed: May 9, 2024

(30) Foreign Application Priority Data
May 11, 2023 (JP) 2023-078783

(51) Int. Cl. G06V 30/19; G06V 30/148; G06V 30/18; G06V 30/41

(52) U.S. Cl. CPC G06V 30/19093; G06V 30/15; G06V 30/18; G06V 30/191; G06V 30/41

(57) ABSTRACT

An information processing device includes one or more hardware processors configured to function as a reception unit, an extraction unit, a calculation unit, and a determination unit. The reception unit receives inputs of an image including image regions having a specific relation and region information indicating a first image region in the image. The extraction unit extracts one or more second image regions from the image. The calculation unit calculates a relational-feature indicating a relation between the first image region indicated by the region information and another image region in the image by using the image, and calculates a self-feature indicating a feature of a region for each second image region. The determination unit determines the second image region having the specific relation with the first image region based on a similarity between the relational feature and the self-feature.

### CROSS-REFERENCE TO RELATED APPLICATIONS

This application is based upon and claims the benefit of priority from Japanese Patent Application No. 2023-078783, filed May 11, 2023, the entire contents of which are incorporated herein by reference.

### FIELD

Embodiments described herein relate generally to an information processing device, an information processing method, and a computer program product.

### BACKGROUND

An optical character recognition service for reading information from an image of a fixed-form document requires preliminary processing such as setting a region for reading information (reading region). In some cases, a plurality of reading regions in the image have a mutual, specific relation (such as a hierarchical relation).

As a technique of extracting information required for converting layout of a document including a rectangle, a technique of determining a hierarchical structure of a plurality of regions in the image is proposed.

However, the technique as described above requires, for example, processing of performing character recognition on an image, and processing of converting character recognition data to generate information indicating meaning (meaning tag information).

### BRIEF DESCRIPTION OF THE DRAWINGS

FIG. 1 is a block diagram illustrating an example of a configuration of an information processing device according to an embodiment;

FIG. 2 is a diagram illustrating an example of an image region in an image of a document;

FIG. 3 is a diagram illustrating an example of a feature to be calculated;

FIG. 4 is a diagram illustrating an example of determination performed by a determination unit;

FIG. 5 is a diagram illustrating an example of determination performed by the determination unit;

FIG. 6 is a flowchart illustrating an example of determination processing according to the embodiment;

FIG. 7 is a diagram illustrating an example of a structure of a model;

FIG. 8 is a diagram illustrating an example of a structure of a model;

FIG. 9 is a diagram illustrating an example of a structure of a model;

FIG. 10 is a diagram illustrating an example of a structure of a model;

FIG. 11 is a diagram for explaining an example of calculating a plurality of relational features;

FIG. 12 is a diagram for explaining a configuration example of input data to be input to a GNN; and

FIG. 13 is an explanatory diagram illustrating a hardware configuration example of an information processing device according to the embodiment.

### DETAILED DESCRIPTION

According to an embodiment, an information processing device includes one or more hardware processors configured to function as a reception unit, an extraction unit, a calculation unit, and a determination unit. The reception unit is configured to receive inputs of an image including a plurality of image regions having a specific relation and region information indicating a first image region in the image. The extraction unit is configured to extract one or more second image regions from the image. The calculation unit is configured to calculate a relational feature indicating a relation between the first image region indicated by the region information and another image region in the image by using the image, and calculate a self-feature indicating a feature of a region for each of the second image regions. The determination unit is configured to determine the second image region having the specific relation with the first image region based on a similarity between the relational feature and the self-feature. The following describes a preferred embodiment of an information processing device according to the present disclosure in detail with reference to the attached drawings.

The following mainly describes an example of applying the embodiment to a recognition service for reading information from an image of a document, but a technique to which the embodiment can be applied is not limited to the recognition service. The following embodiment can be applied to another technique, service, system, device, or the like that uses a function of determining whether a plurality of regions included in an image have a specific relation.

As described above, in the recognition service, a reading region for reading information needs to be set in advance. As a preliminary setting, work of setting a caption for the reading region is required in some cases. Such setting work is executed by a user, for example. On the other hand, if a function of setting a caption by analyzing an image is implemented, the setting work is not required to be performed by the user.

The function of setting a caption is required to estimate a caption appropriate for each region for a plurality of regions having a specific relation. The specific relation is, for example, a hierarchical relation in which a plurality of regions have a hierarchical structure. For such a function, a relation among plurality regions is desired to be determined with a simpler configuration at a higher speed.

The information processing device according to the present embodiment calculates, for each of the regions in the image, a feature of the region itself (self-feature) and a feature indicating a relation with another region in the image (relational feature). These features are the used to determine whether the regions have a specific relation (such as a hierarchical relation). A model that has been learned in advance is used for calculating the feature. Due to this, for example, character recognition processing, processing of generating information indicating meaning, and the like are made unnecessary, and presence/absence of a specific relation can be determined with a simpler configuration at a higher speed.

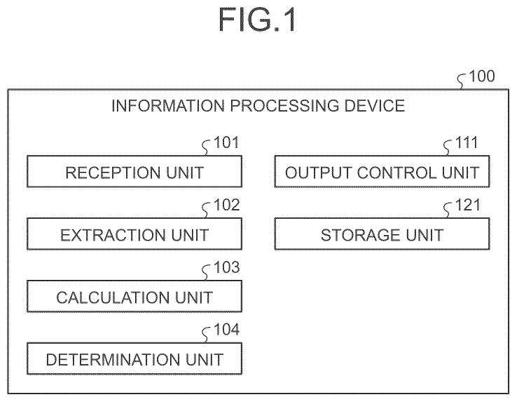

FIG. 1 is a block diagram illustrating an example of a configuration of an information processing device 100 according to the embodiment. As illustrated in FIG. 1, the information processing device 100 includes a reception unit 101, an extraction unit 102, a calculation unit 103, a determination unit 104, an output control unit 111, and a storage unit 121.

The reception unit 101 receives inputs of various kinds of information used in the information processing device 100. For example, the reception unit 101 receives inputs of an image IDA including a plurality of image regions having a specific relation, and region information indicating an image region IRA (first image region) in the image IDA.

The image IDA is, for example, data obtained by reading a document by a reading device such as a scanner. The image region IRA is, for example, an image region designated as a region for which a caption is set. The region information is information indicating a position (coordinates) of the image region IRA in the image IDA. Hereinafter, the image region IRA may be referred to as an input region.

The input region (region information) may be designated by the user or the like, for example, or a region extracted from the image IDA may be set as the input region. In the latter case, not only work of setting a caption but also work of setting an image region for which a caption is set are made unnecessary.

The extraction unit 102 extracts one or more image regions IRB (second image regions) from the image IDA. The extracted image region IRB is a region as a candidate for a region having a specific relation with the input region (image region IRA). Hereinafter, the image region IRB may be referred to as a candidate region.

As described above, in a case of a configuration for extracting the input region from the image IDA, for example, the extraction unit 102 extracts one or more image regions from the image IDA, making any of the extracted image regions as the input region, and making the information indicating the position of the input region as the region information.

A method for extracting the region (the candidate region, the input region) from the image by the extraction unit 102 may be any method that has been conventionally used, and the following methods can be applied, for example.
(M1) Method by random sampling from vicinity of input region
(M2) Rule-based method using ruled lines
(M3) Semantic segmentation using Deep Neural Network (DNN)
(M4) Method using object detection based on bounding box using DNN (for example, You Only Look Once (YOLO), Single Shot multibox Detector (SSD), and the like)

In (M3) and (M4), the DNN is learned in advance so that the candidate region can be extracted.

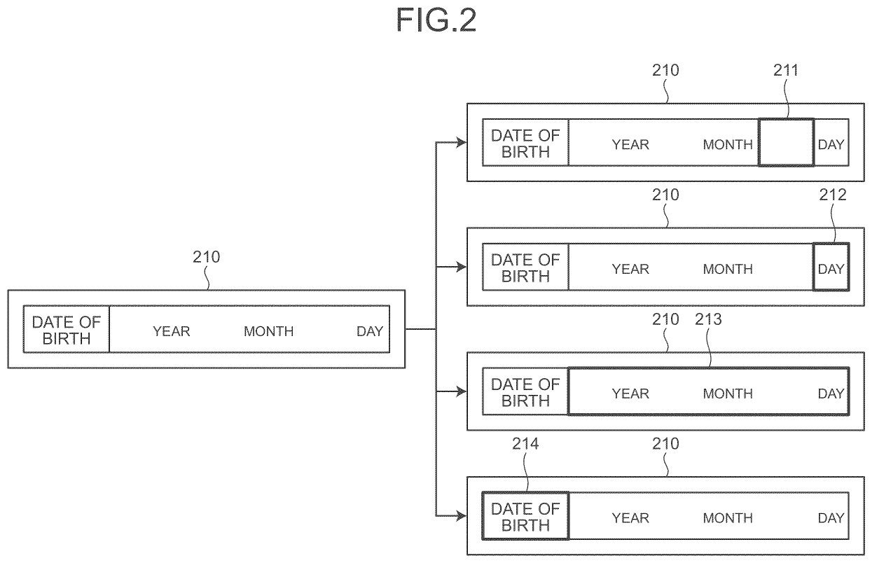

FIG. 2 is a diagram illustrating an example of the image region in the image of the document. FIG. 2 illustrates an example of an image 210 including an entry region for entering a date of birth. The image 210 may be data including two or more entry regions.

As illustrated in FIG. 2, the image 210 includes image regions 211 to 214. The image regions 211 to 214 respectively correspond to the following regions.
Image region 211: an entry region for entering a day of the date of birth
Image region 212: a region to which characters of “day” corresponding to a caption of the image region 211 is output
Image region 213: an entry region for entering the date of birth
Image region 214: a region to which characters of “date of birth” corresponding to a caption of the image region 213 are output

It can be interpreted that the image region 211 and the image region 212 have a specific relation of being the entry region about the “day” and the region to which the caption is output. Assuming that the entry region is at a lower level and the region to which the caption is output is at a higher level, it can be interpreted that they have a hierarchical relation.

Similarly, it can be interpreted that the image region 213 and the image region 214 have a specific relation of being the entry region about the “date of birth” and the region to which the caption is output.

Furthermore, the image region 214 corresponds to a region to which the “date of birth” including the “day” output to the image region 212 is output. Thus, it can be interpreted that the image region 214 is a higher-level region with respect to the image region 212, in other words, the image region 214 and the image region 212 have a hierarchical relation. In the present embodiment, it is possible to determine a plurality of image regions having such a specific relation.

Each of the image regions 211 to 214 may become an input region, or may become a candidate region. For example, the image region 211 is designated as the input region, and the image regions 212 to 214 are extracted as candidate regions in some cases. For example, the image region 213 is designated as the input region, and the image regions 211, 212, and 214 are extracted as candidate regions in some cases.

Returning to FIG. 1, the calculation unit 103 calculates a feature of the image region. For example, the calculation unit 103 calculates a self-feature and a relational feature for each of the input region and the candidate region by using the input image IDA.

The self-feature indicates a feature of the image region itself. The relational feature is a feature indicating a relation between the image region and another image region in the image IDA.

For example, the calculation unit 103 calculates the self-feature and the relational feature by using a model that receives inputs of the image IDA and the region information and outputs the self-feature and the relational feature. The model may have any structure, and may be a neural network model constructed by machine learning, for example.

The model is constructed by preliminary learning using learning data. For example, the model is learned so that, among the image regions included in the image, a similarity between the self-feature of the image region having a specific relation with the image region IRA indicated by the region information and the relational feature output from the model is larger than a similarity between the self-feature of an image region not having a specific relation with the image region IRA and the relational feature output from the model.

In other words, the model is learned so that, regarding the image regions, the feature (self-feature) of another image region having a specific relation with the image region is output as the relational feature together with the feature (self-feature) of the image region itself. Details about a model that can be used for processing of extracting the feature by the calculation unit 103 will be described later.

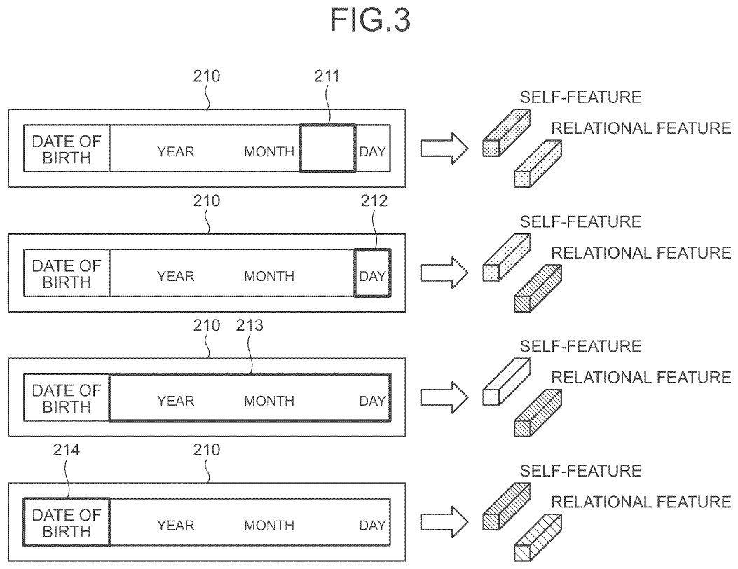

FIG. 3 is a diagram illustrating an example of features calculated for the image regions 211 to 214 in FIG. 2. As illustrated in FIG. 3, the calculation unit 103 calculates the self-feature and the relational feature for each of the image regions 211 to 214. Two features including the same hatching are similar to each other or agree with each other. For example, hatching of the relational feature of the image region 211 is the same as that of the self-feature of the image region 212. This means that the image region 211 and the image region 212 have a specific relation. In the present embodiment, the specific relation can be determined based on such a correspondence between the self-feature and the relational feature (whether they are similar to each other).

Returning to FIG. 1, the determination unit 104 determines the image region IRB having a specific relation with the image region IRA based on the similarity between the relational feature and the self-feature. The feature is represented by a vector, for example. In this case, the determination unit 104 can calculate the similarity between the relational feature and the self-feature based on a cosine similarity between two vectors, an inverse number of a distance between the two vectors, and the like.

Assuming that the two vectors are u and v, a cosine similarity between the vectors u and v is represented by the following expression (1), for example.

$$Sim ( u , v ) = {u}^{T} v \qquad ( 1 )$$

As the inverse number of the distance between the vectors, for example, an inverse number of an L2 distance can be used as represented by the following expression (2), for example. The distance is not limited to the L2 distance.

$$Sim ( u , v ) = 1 / {\vert \vert u - v \vert \vert}_{2} \qquad ( 2 )$$

A method for calculating the similarity is not limited to the method described above, and may be any method that has been conventionally used. For example, the determination unit 104 may calculate, as the similarity, a value obtained by inverting a sign of the distance (for example, multiplying by −1) instead of the inverse number of the distance.

In a case of using the similarity that represents higher similarity as the value thereof is smaller, the distance itself between the vectors or an inverse number of the cosine similarity may be used as the similarity.

By using the similarity calculated as described above, the determination unit 104 determines the image region IRB having a specific relation with the image region IRA among the extracted one or more image regions IRB. For example, the determination unit 104 determines the image region IRB the similarity of which is equal to or larger than a threshold (threshold of similarity) as the image region IRB having a specific relation with the image region IRA.

Furthermore, regarding the image region IRB determined to have the specific relation with the image region IRA, the determination unit 104 may recursively search for another image region IRB having the specific relation therewith.

The calculation unit 103 calculates the self-feature and the relational feature for all of input regions (image regions IRA) and the extracted candidate regions (image regions IRB). Thus, the determination unit 104 can use the calculated self-feature and relational feature for recursive search.

For example, based on the similarity between the relational feature calculated for the image region IRB that is determined to have a specific relation with the image region IRA and the self-feature of another image region IRB, the determination unit 104 further determines another image region IRB having a specific relation with the image region IRB.

In a case of not using the self-feature and the relational feature later such as a case of not performing recursive search, the calculation unit 103 may be configured not to calculate the self-feature of the input region or the relational feature of the candidate region.

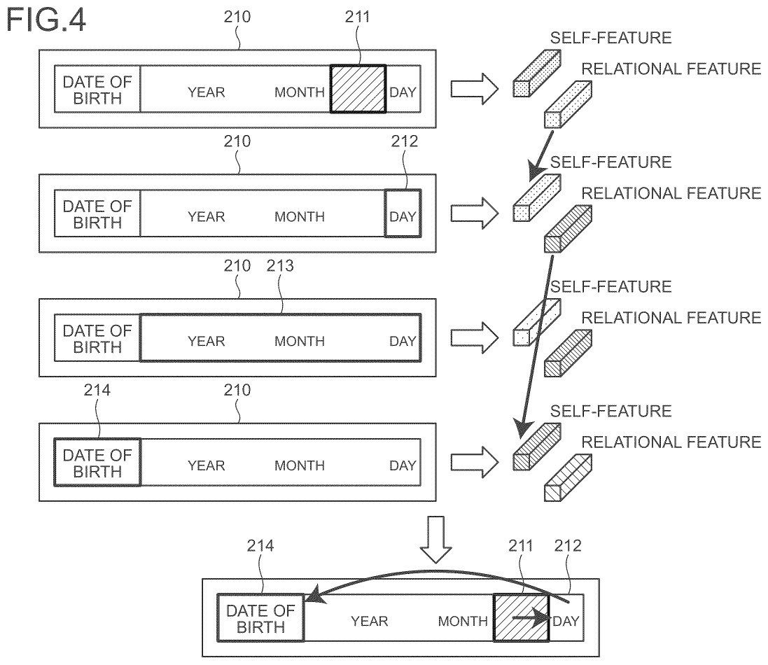

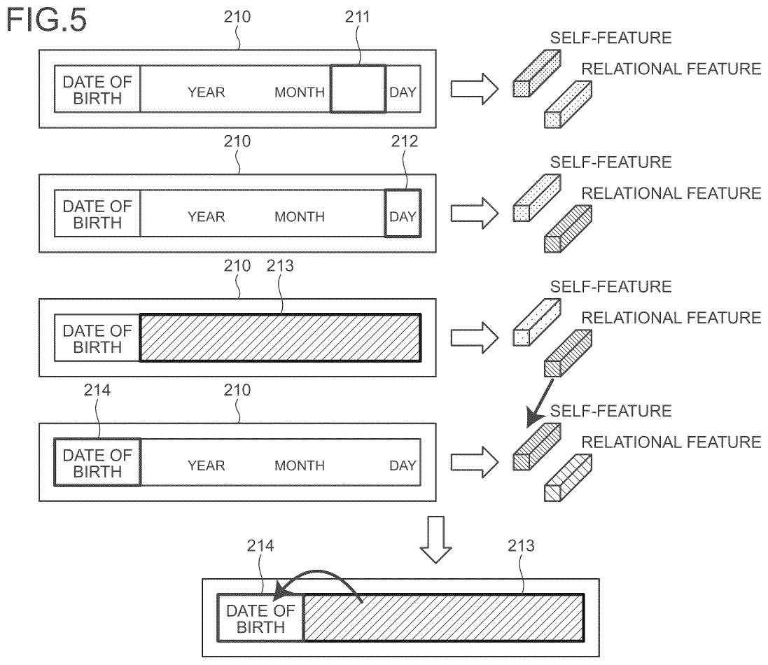

FIG. 4 and FIG. 5 are diagrams illustrating an example of determination performed by the determination unit 104. FIG. 4 illustrates an example of determination in a case in which an input is made to the image region 211 as the input region (image region IRA).

In this case, first, the determination unit 104 determines that the image region IRB having the self-feature the similarity of which to the relational feature of the image region 211 is equal to or larger than the threshold is the image region 212. In a case of performing recursive search, the determination unit 104 determines that the image region IRB having the self-feature the similarity of which to the relational feature of the image region 212 is equal to or larger than the threshold is the image region 214.

As a result, the determination unit 104 can obtain the image region 212 as a region at a higher level in the hierarchy than the image region 211, and obtain the image region 214 as a region at a higher level in the hierarchy than the image region 212. The determination unit 104 may output information indicating such a hierarchical structure.

FIG. 5 illustrates an example of determination in a case in which an input is made to the image region 213 as the input region (image region IRA). In this case, the determination unit 104 determines that the image region IRB having the self-feature the similarity of which to the relational feature of the image region 213 is equal to or larger than the threshold is the image region 214. Although recursive search can be performed, in the example of FIG. 5, there is no image region IRB having the self-feature the similarity of which to the relational feature of the image region 214 is equal to or larger than the threshold, so that the image region corresponding to a higher level in the hierarchy is not obtained.

FIG. 4 and FIG. 5 are examples of searching for an image region at a higher level in the hierarchy starting from the input region. The hierarchical relation may be determined by searching for an image region at a lower level in the hierarchy starting from the input region. For example, when a region corresponding to a title of a document (document name) is designated as the input region, an image region corresponding to one or more entry regions included in the document having a title corresponding to the input region may be searched for as a region corresponding to a lower level in the hierarchy than the input region. Regarding the hierarchical relation, search may be performed in both directions including a higher-level direction and a lower-level direction.

Returning to FIG. 1, the output control unit 111 controls output of various kinds of information used by the information processing device 100. For example, the output control unit 111 outputs a determination result (structure information) obtained by the determination unit 104.

Each of the units described above (the reception unit 101, the extraction unit 102, the calculation unit 103, the determination unit 104, and the output control unit 111) is implemented by one or a plurality of processors, for example. For example, each of the units described above may be implemented by causing a processor such as a central processing unit (CPU) and a graphics processing unit (GPU) to execute a computer program, that is, by software. Each of the units described above may also be implemented by a processor such as a dedicated integrated circuit (IC), that is, by hardware. Each of the units described above may also be implemented by using both of software and hardware. In a case of using a plurality of processors, each of the processors may implement one of the units, or may implement two or more of the units.

The storage unit 121 stores various kinds of information used in the information processing device. For example, the storage unit 121 stores information (the image IDA, the region information, and the like) received by the reception unit 101.

The storage unit 121 can be configured by any generally used storage medium such as a flash memory, a memory card, a random access memory (RAM), a hard disk drive (HDD), and an optical disc.

The information processing device 100 may be physically configured by one device, or may be physically configured by a plurality of devices. For example, the information processing device 100 may be constructed in a cloud environment. The units in the information processing device 100 may be distributed to a plurality of devices.

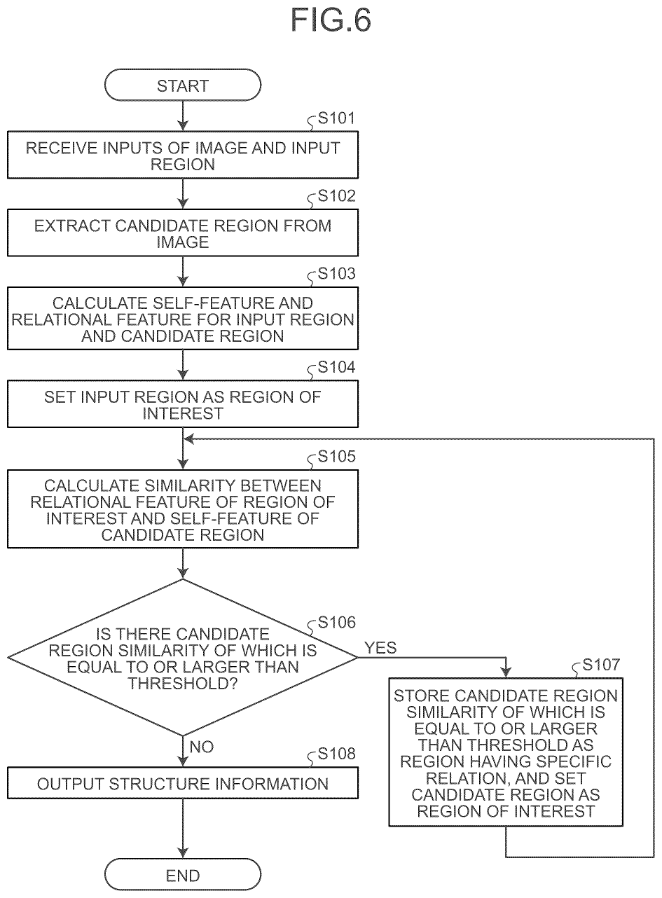

Next, the following describes determination processing performed by the information processing device 100 according to the embodiment. FIG. 6 is a flowchart illustrating an example of the determination processing according to the embodiment.

The reception unit 101 receives inputs of the image IDA and the region information indicating the input region (image region IRA) in the image IDA (Step S101). The extraction unit 102 extracts one or more candidate regions from the image IDA (Step S102). The calculation unit 103 calculates the self-feature and the relational feature for each of the input region and the candidate region (Step S103).

The determination unit 104 sets the input region as a region of interest (Step S104). The region of interest means an image region as a target for determining another image region having a specific relation therewith.

The determination unit 104 calculates a similarity between the relational feature of the region of interest and the self-feature of the candidate region (Step S105). The determination unit 104 determines whether there is a candidate region the similarity of which is equal to or larger than the threshold (Step S106).

If there is the candidate region the similarity of which is equal to or larger than the threshold (Yes at Step S106), the determination unit 104 stores the candidate region the similarity of which is equal to or larger than the threshold in the storage unit 121, for example, as a region having a specific relation with the region of interest, and sets it as a new region of interest (Step S107). The determination unit 104 returns the process to Step S105, and repeats the processing for the new region of interest. Due to this, recursive search can be performed.

If there is no candidate region the similarity of which is equal to or larger than the threshold (No at Step S106), the output control unit 111 outputs structure information indicating the specific relation that has been obtained by the determination unit 104 (Step S108), and ends the determination processing.

The structure information can be used for work of setting a caption, for example. For example, the information processing device 100 (or another appliance having a function of setting a caption) makes a region determined to be at a higher-level in the hierarchy than the input region as a region for a caption, and performs character recognition on the region for the caption to specify the caption.

A function of using the structure information is not limited to caption setting, but may be any other function. For example, the function may be a function of displaying information indicating a relation among a plurality of regions based on the structure information indicating the relation among the regions included in a document to be edited. Such a function can improve efficiency of work of editing the document in the region, for example.

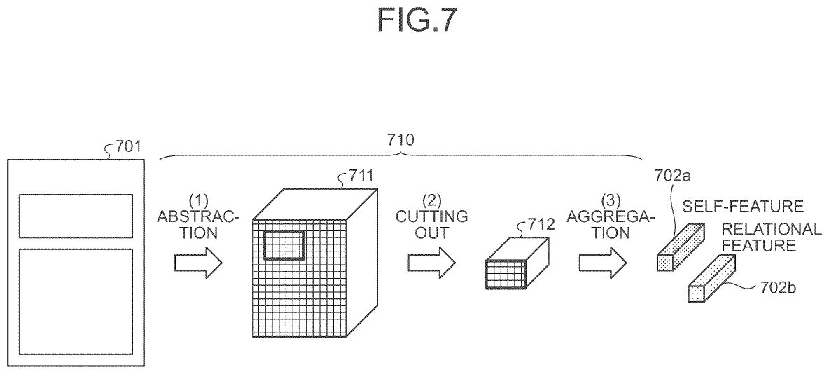

Next, the following describes details about a model that can be used for processing of extracting the feature. FIG. 7 is a diagram illustrating an example of a structure of a model 710.

The model 710 receives an input of the image IDA and the region information indicating the image region in the image IDA, and outputs a self-feature 702a and a relational feature 702b. In FIG. 7, an image 701 corresponds to the image IDA. The image region designated by the region information may be the input region, or may be the candidate region.

The model 710 mainly has three functions as follows, and outputs the self-feature 702a and the relational feature 702b as final outputs.
(1) Abstraction
(2) Cutting out
(3) Aggregation

As described below, each of the three functions may be implemented by a plurality of methods. In accordance with a combination of methods employed from among the above methods, the model 710 may take a plurality of different configurations. Some of the methods cannot be combined with each other.

In abstraction in (1), a feature 711 obtained by abstracting the input image 701 is output. The feature 711 is, for example, represented in a data format such as a third-order tensor having a dimension in a depth direction in addition to a width and a height. The abstraction is implemented by the following method, for example.

(1-1) Not perform abstraction (the image 701 is output as the feature 711).

(1-2) Use a feature extractor that has performed preliminary learning by using a database (such as ImageNet) prepared in advance. The feature extractor is, for example, a Deep Neural Network (DNN).

(1-3) Implement the abstraction as a function of abstraction among functions of the model 710 that is learned as a stand-alone model. For example, the model 710 is a DNN, and the function of abstraction corresponds to a function of some of layers of the DNN.

In (1-2), it takes more time for inference than (1-1), but the processing can be performed with higher accuracy. In (1-3), it takes more time for learning than (1-2), but the processing can be performed with higher accuracy.

In cutting out in (2), a feature 712 partially cut out from the feature 711 is output. Cutting out in (2) is implemented by the following method, for example.

(2-1) Cut out the feature 712 corresponding to a designated image region (the input region, the candidate region) from the feature 711.

(2-2) Cut out the feature 712 corresponding to a peripheral region of the designated image region from the feature 711. The peripheral region is, for example, a region having a distance to the designated image region equal to or smaller than a certain value.

By cutting out the feature 712 corresponding to the peripheral region as in (2-2), the processing can be performed with higher accuracy in some cases.

In the aggregation in (3), the self-feature 702a and the relational feature 702b are output by aggregating the feature 712. The aggregation in (3) is implemented by the following method, for example.

(3-1) Calculate a representative vector by pooling the feature 712, and output the representative vector as the self-feature 702a and the relational feature 702b. The pooling is, for example, AveragePooling and MaxPooling. In a case of not performing abstraction ((1-1) described above), the feature to be subjected to pooling cannot be obtained, so that (3-1) cannot be combined therewith.

(3-2) Convert the feature 712 into the self-feature 702a and the relational feature 702b to be output by using the DNN. In this method, it takes time for inference and learning of the DNN, but the processing can be performed with higher accuracy.

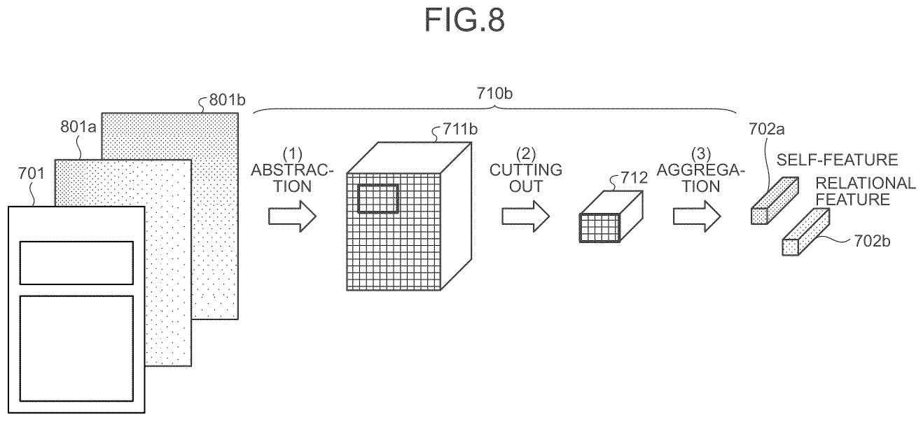

As an input to the model, information indicating a position of each element (pixel) included in the image 701 may be added. FIG. 8 is a diagram illustrating an example of a structure of such a model 710b.

As illustrated in FIG. 8, the model 710b receives inputs of pieces of information 801a and 801b indicating positions in addition to the image IDA and the region information. The information 801a is, for example, information including elements corresponding to respective pixels of the image 701, the information for which an element value varies from a maximum value (for example, 1) to a minimum value (for example, 0) from an element on a left end toward an element on a right end. The information 801b is, for example, information including elements corresponding to respective pixels of the image 701, the information for which the element value varies from the maximum value (for example, 1) to the minimum value (for example, 0) from an element on an upper end toward an element on a lower end.

The pieces of information 801a and 801b may be generated by positional encoding. Only one of the pieces of information 801a and 801b may be used.

A feature 711b is a feature obtained by abstracting the input image 701 and the pieces of information 801a and 801b.

The pieces of information 801a and 801b may be added in the function of abstraction. For example, the pieces of information 801a and 801b may be added in any of intermediate layers of the DNN that implements abstraction.

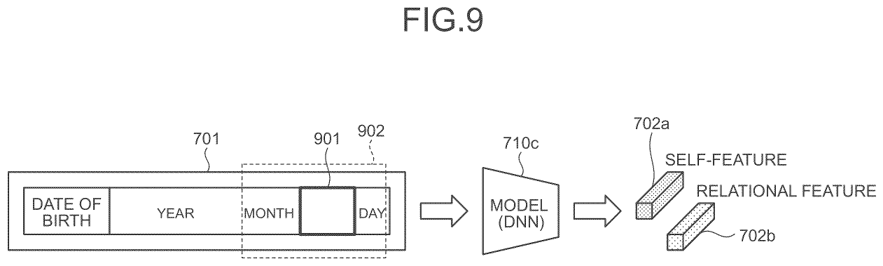

The following further describes a specific example of the model. FIG. 9 is a diagram illustrating an example of the model (model 710c). FIG. 9 is an example of the model 710c obtained by combining the methods of the three functions as follows.
Abstraction: (1-1) Not perform abstraction.
Cutting out: (2-2) Cut out the feature corresponding to the peripheral region.
Aggregation: (3-2) Convert the feature by the DNN.

In the example of FIG. 9, region information indicating a peripheral region 902 of an image region 901 is input to the model 710c. Alternatively, region information indicating the image region 901 may be input to the model 710c, and the region information of the peripheral region 902 of the input image region 901 may be calculated inside the model 710c.

The model 710c is learned to receive inputs of the image and the region information, and output the self-feature 702a and the relational feature 702b for the region indicated by the region information.

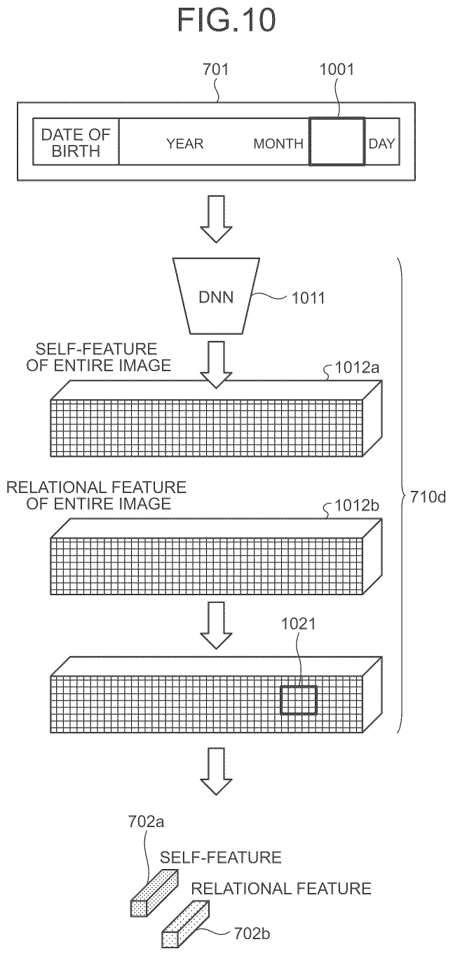

FIG. 10 is a diagram illustrating another example of the model (model 710d). FIG. 10 is an example of the model 710d obtained by combining the methods of the three functions as follows.
Abstraction: (1-3) A function of abstraction of the stand-alone model 710d.
Cutting out: (2-1) Cut out the feature corresponding to the designated region.
Aggregation: (3-1) Calculate the representative vector by pooling.

In the example of FIG. 10, the image 701 and region information of an image region 1001 are input to the model 710d. The model 710d includes a DNN 1011 corresponding to the function of abstraction. The DNN 1011 is learned so that, for example, a self-feature 1012a of the entire image 701 and a relational feature 1012b of the entire image 701 are output from the image 701. The self-feature 1012a and the relational feature 1012b of the entire image 701 are, for example, a third-order tensor having dimensions of a width, a height, and a depth and having a correspondence relation with the image 701 in vertical and horizontal directions.

The model 710d cuts out the third-order tensor surrounded by a position 1021 corresponding to the region information of the image region 1001 from the self-feature 1012a, and aggregates width and height directions by pooling processing to output to the self-feature 702a. Similarly, the model 710d cuts out the third-order tensor surrounded by the position 1021 from the relational feature 1012b, and aggregates the width and height directions by pooling processing to output to the relational feature 702b.

Next, the following describes an example of a learning method for the model. As described above, the model is learned so that, among the image regions included in the image, the similarity between the self-feature of the image region having a specific relation with the image region IRA and the relational feature output from the model is larger than the similarity between the self-feature of the image region not having a specific relation with the image region IRA and the relational feature output from the model.

The learning is performed by minimizing a loss function designed by the following procedure, for example.
For combinations of the region of interest and all the other candidate regions, the similarity between the self-feature of the candidate region and the relational feature of the region of interest is calculated.
The loss function is designed so that the similarity becomes larger with a combination having a specific relation, and the similarity becomes smaller with a combination having no specific relation.

For example, a loss function L as represented by the following expression (3) can be used. A function Sim in the expression (3) is a function for calculating the similarity as in the expression (1) or the expression (2).

$$L = - {\sum }_{i < N} {\sum }_{j < N} {σ}_{i , j} Sim ( {ϕ}_{self} ( {R}_{i} ) , {ϕ}_{rel} ( {R}_{j} ) ) \qquad ( 3 )$$

Definitions of respective variables in the expression (3) are described below.
N: Number of regions
Rᵢ: i-th region (1<i<N)
Rⱼ: j-th region (1<j<N)
φ_{self}: function for calculating self-feature from image region
φᵣₑₗ: function for calculating relational feature from image region
σ_{i,j}: 1 when Rⱼ has a specific relation with Rᵢ, otherwise −1 (correct answer data)

A function of the model for obtaining the self-feature corresponds to the function φ_{self} for calculating the self-feature from the image region. A function of the model for obtaining the relational feature corresponds to the function φᵣₑₗ for calculating the relational feature from the image region.

In the example described above, one relational feature is calculated for one image region. The calculation unit 103 may calculate a plurality of relational features from one image region.

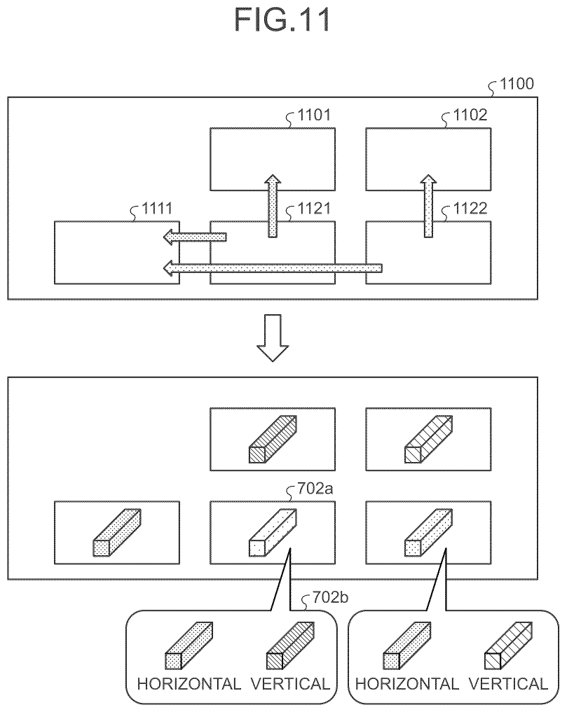

FIG. 11 is a diagram for explaining an example of calculating a plurality of the relational features. Image 1100 illustrated in FIG. 11 is an example of image including elements represented in a table format, for example.

For example, regions 1101 and 1102 are regions to which characters (such as a caption) corresponding to a column of the table format are output. A region 1111 is a region to which characters (such as a caption) corresponding to a row of the table format are output. A region 1121 is an entry region for entering a value corresponding to the region 1101 and the region 1111. A region 1122 is an entry region for entering a value corresponding to the region 1102 and the region 1111. Thus, for example, it can be interpreted that the region 1121 has a specific relation with the region 1101, and also has a specific relation with the region 1111.

While considering such a case, the calculation unit 103 calculates the self-feature 702a, and calculates two relational features 702b corresponding to two directions for the region 1111. The two directions are, for example, a column direction (vertical direction) and a row direction (horizontal direction). The relational features to be calculated are not limited thereto. The calculation unit 103 may calculate three or more relational features.

In a case of using a plurality of the relational features, a loss function including similarities to the respective relational features is used at the time of learning. For example, a loss function including multiplication of σ_{i,j} and the similarity (Sim) in the expression (3) for each of the relational features is used.

Due to this, it is possible to determine a relation among a plurality of regions for various documents including a document for which a plurality of captions are set for one entry region, for example.

Next, the following describes another example of the method for calculating the similarity. The similarity may be calculated by using a model that is learned to calculate the similarity (hereinafter, referred to as a similarity calculation model).

The similarity calculation model is, for example, a DNN. The similarity calculation model is learned to receive, for example, inputs of the relational feature of the region of interest and the self-feature of the candidate region, and output the similarity. The inputs may be the relational feature and the self-feature of the region of interest, and the self-feature of the candidate region.

The similarity calculation model may be learned together with a model used for calculating the feature by the calculation unit 103, or may be learned in advance separately from that model. By using such a similarity calculation model, the processing can be performed with higher accuracy although a calculation time is increased.

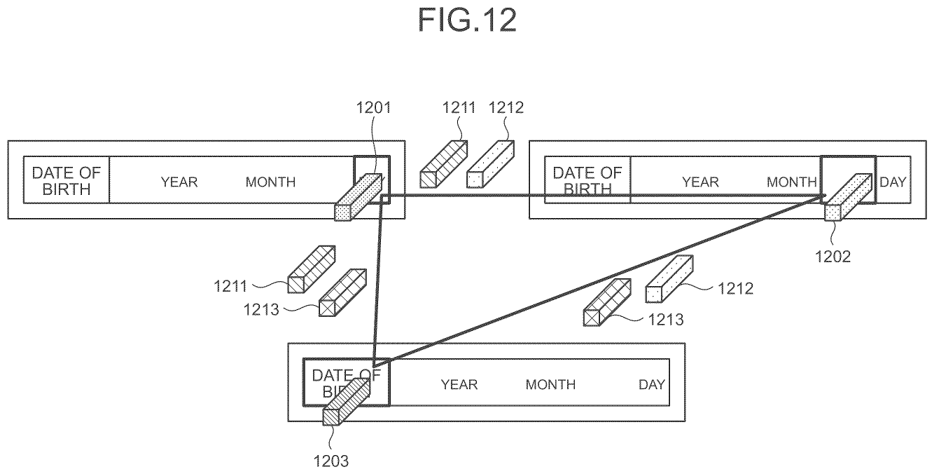

The similarity may also be calculated by using a graph neural network (GNN). FIG. 12 is a diagram for explaining a configuration example of input data to be input to the GNN. In this example, the input data is configured with self-features 1201 to 1203 of respective image regions as nodes, and with a feature obtained by integrating (for example, coupling) relational features (1211 to 1213) of two image regions as an edge connecting the two image regions. For example, the edge connecting two nodes respectively corresponding to the self-feature 1201 and the self-feature 1202 is equated to the feature obtained by integrating the relational features 1211 and 1212.

The GNN is learned to receive an input of the input data having a graph structure as illustrated in FIG. 12, and output the feature of the input data. For example, the GNN is learned to output 1 as the feature for an edge corresponding to two image regions having a specific relation, and output 0 as the feature for an edge corresponding to two image regions having no specific relation. It can be interpreted that such a feature is information representing the similarity between the features of the two image regions.

The determination unit 104 inputs the input data having the graph structure as illustrated in FIG. 12 to the GNN, and obtains the feature (similarity) output from the GNN. By calculating the similarity using the GNN, the processing can be performed with higher accuracy although a calculation time is increased.

In this way, in the embodiment described above, it is determined whether a plurality of regions have a specific relation (such as a hierarchical relation) by using the self-feature and the relational feature calculated for each of the regions in the image. Due to this, presence/absence of a specific relation can be determined with a simpler configuration.

Additionally, by using information (structure information) indicating a determination result, for example, a function of setting a caption for a document recognition service can be implemented. In setting a caption, regions different in granularity may be designated as regions to which captions are set. For example, as a region for entering a date of birth, one region may be designated for the entire date of birth, or individual regions may be designated for a year, a month, and a day, respectively. According to the embodiment described above, in any of these cases, another region having a specific relation can be efficiently searched for based on the designated region.

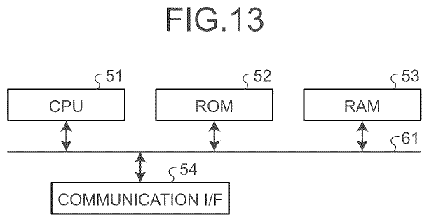

Next, the following describes a hardware configuration of the information processing device according to the embodiment with reference to FIG. 13. FIG. 13 is an explanatory diagram illustrating a hardware configuration example of the information processing device according to the embodiment.

The information processing device according to the embodiment includes a control device such as a CPU 51, a storage device such as a read only memory (ROM) 52 and a RAM 53, a communication I/F 54 that is connected to a network to perform communication, and a bus 61 that connects the respective units.

A computer program executed by the information processing device according to the embodiment is embedded and provided in the ROM 52, for example.

The computer program executed by the information processing device according to the embodiment may be recorded in a computer-readable recording medium such as a compact disk read only memory (CD-ROM), a flexible disk (FD), a compact disk recordable (CD-R), and a digital versatile disk (DVD) to be provided as a computer program product, as an installable or executable file.

Furthermore, the computer program executed by the information processing device according to the embodiment may be stored in a computer connected to a network such as the Internet and provided by being downloaded via the network. The computer program executed by the information processing device according to the embodiment may be provided or distributed via a network such as the Internet.

The computer program executed by the information processing device according to the embodiment may cause a computer to function as the respective units of the information processing device described above. In this computer, the CPU 51 can read out the computer program from a computer-readable storage medium onto a main storage device to be executed.

While certain embodiments have been described, these embodiments have been presented by way of example only, and are not intended to limit the scope of the inventions.

Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
one or more hardware processors configured to function as: a reception unit configured to receive inputs of an image including a plurality of image regions having a specific relation and region information indicating a first image region in the image;
an extraction unit configured to extract one or more second image regions from the image;
a calculation unit configured to calculate a relational feature indicating a relation between the first image region indicated by the region information and another image region in the image by using the image, and calculate a self-feature indicating a feature of a region for each of the second image regions; and
a determination unit configured to determine the second image region having the specific relation with the first image region based on a similarity between the relational feature and the self-feature.

2. The information processing device according to claim 1, wherein
the calculation unit calculates the relational feature by using a model that outputs the relational feature based on the image that is input and the region information, and
the model is learned in advance such that, among the image regions included in the image, the similarity between the self-feature of the image region having the specific relation with the first image region and the relational feature output from the model is larger than the similarity between the self-feature of an image region not having the specific relation with the first image region and the relational feature output from the model.

3. The information processing device according to claim 2, wherein the model obtains the relational feature of an entire image, and cut outs the relational feature of the first image region from the relational feature of the entire image based on the region information.

4. The information processing device according to claim 2, wherein the model further receives an input of information indicating a position of each element included in the image, and outputs the relational feature.

5. The information processing device according to claim 1, wherein
the calculation unit calculates the relational feature for the second image region that is determined to have the specific relation with the first image region, and
the determination unit further determines the second image region having the specific relation with the second image region that is determined to have the specific relation with the first image region based on a similarity between the self-feature and the relational feature calculated for the second image region that is determined to have the specific relation with the first image region.

6. The information processing device according to claim 1, wherein the specific relation is a hierarchical relation.

7. The information processing device according to claim 1, wherein the calculation unit calculates a plurality of the relational features for the first image region indicated by the region information.

8. The information processing device according to claim 1, wherein the determination unit calculates the similarity by using a graph neural network with the self-feature as a node and the relational feature as an edge.

9. An information processing method implemented by an information processing device including a computer, the information processing method comprising:
receiving inputs of image including a plurality of image regions having a specific relation and region information indicating a first image region in the image;
extracting one or more second image regions from the image;
calculating a relational feature indicating a relation between the first image region indicated by the region information and another image region in the image by using the image, and calculating a self-feature indicating a feature of a region for each of the second image regions; and
determining the second image region having the specific relation with the first image region based on a similarity between the relational feature and the self-feature.

10. A computer program product having a non-transitory computer readable medium including programmed instructions stored thereon, wherein the instructions, when executed by a computer, cause the computer to execute:
receiving inputs of image including a plurality of image regions having a specific relation and region information indicating a first image region in the image;
extracting one or more second image regions from the image;
calculating a relational feature indicating a relation between the first image region indicated by the region information and another image region in the image by using the image, and calculating a self-feature indicating a feature of a region for each of the second image regions; and
determining the second image region having the specific relation with the first image region based on a similarity between the relational feature and the self-feature.
